(19) United States
(12) Patent Application Publication
(10) Pub. No.: US 2024/0394332 A1
(43) Pub. Date: Nov. 28, 2024

(54) EFFICIENT VECTOR COMPARISON FOR EVENT IDENTIFICATION

(71) Applicant: BRITISH TELECOMMUNICATIONS PUBLIC LIMITED COMPANY, LONDON (GB)

(72) Inventors: Jonathan ROSCOE, London (GB); Robert HERCOCK, London (GB); Max SMITH-CREASEY, London (GB)

(21) Appl. No.: 18/693,580

(22) PCT Filed: Aug. 24, 2022
(86) PCT No.: PCT/EP2022/073620

§ 371 Date: Mar. 20, 2024

(30) Foreign Application Priority Data
Sep. 21, 2021 (GB) 2113474.7

(51) Int. Cl. G06F 17/16

(52) U.S. Cl. CPC G06F 17/16

(57) ABSTRACT

A computer implemented method for detecting the existence of a condition indicated by a signature vector sequence of events in an input vector sequence of events, each of the signature and input vector sequences being constituted by an ordered sequence of vectors, can include converting the signature vector sequence into an signature ordered numerical sequence in which each vector in the signature vector sequence is converted to a number indicative of a magnitude of the vector such that the signature numerical sequence is a sequence of magnitudes in the order of the signature vector sequence; converting the input vector sequence into an input ordered numerical sequence in which each vector in the input vector sequence is converted to a number indicative of a magnitude of the vector such that the input numerical sequence is a sequence of magnitudes in the order of the input vector sequence; and determining a degree of similarity of the signature numerical sequence and the input numerical sequence to detect the existence of the condition indicated by the input numerical sequence.

### PRIORITY CLAIM

The present application is a National Phase entry of PCT Application No. PCT/EP2022/073620, filed Aug. 24, 2022, which claims priority from GB Application No. 2113474.7, filed Sep. 21, 2021, each of which hereby fully incorporated herein by reference.

### TECHNICAL FIELD

The present disclosure relates to the identification of the existence of a condition identified by data represented by a vector sequence.

### BACKGROUND

The detection of certain occurrences in computer systems, networks, telecommunications networks and the like can be beneficial for the purpose of, inter alia, identifying security threats, security flaws, performance information, process monitoring, information security and data monitoring. The use of data summarization, classification and machine learning processing techniques increasingly leads to the representation of occurrences as sequences of events. Such sequences can be represented as vectors through, for example, a vector embedding process. Accordingly, the detection of occurrences can resolve to a process of comparing vectors which can be resource-intensive, especially where many vectors are involved.

### SUMMARY

It is therefore beneficial to provide for the efficient comparison of vectors.

According to a first aspect of the present disclosure, there is provided a computer implemented method for detecting the existence of a condition indicated by a signature vector sequence of events in an input vector sequence of events, each of the signature and 30 input vector sequences being constitute by an ordered sequence of vectors, the method comprising: converting the signature vector sequence into an signature ordered numerical sequence in which each vector in the signature vector sequence is converted to a number indicative of a magnitude of the vector such that the signature numerical sequence is a sequence of magnitudes in the order of the signature vector sequence; converting the input vector sequence into an input ordered numerical sequence in which each vector in the input vector sequence is converted to a number indicative of a magnitude of the vector such that the input numerical sequence is a sequence of magnitudes in the order of the input vector sequence; determining a degree of similarity of the signature numerical sequence and the input numerical sequence to detect the existence of the condition indicated by the input numerical sequence.

In some embodiments, determining a degree of similarity includes applying a dynamic time warping algorithm to measure a degree of similarity between the two sequences.

In some embodiments, the condition is a security condition and responsive to a determination that the degree of similarity meets a predetermined threshold degree of similarity, triggering a responsive measure to mitigate the security condition.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of implementations of the present disclosure.

FIG. 2 is a component diagram of an arrangement for detecting the existence of a condition indicated by a signature vector sequence of events in an input vector sequence of events according to an exemplary implementation of the present disclosure.

FIG. 3 is an illustration of exemplary signature and input vector sequences suitable for an exemplary implementation of the present disclosure.

FIG. 4 is a flowchart of a method for detecting the existence of a condition indicated by a signature vector sequence of events in an input vector sequence of events according to an exemplary implementation of the present disclosure.

### DETAILED DESCRIPTION

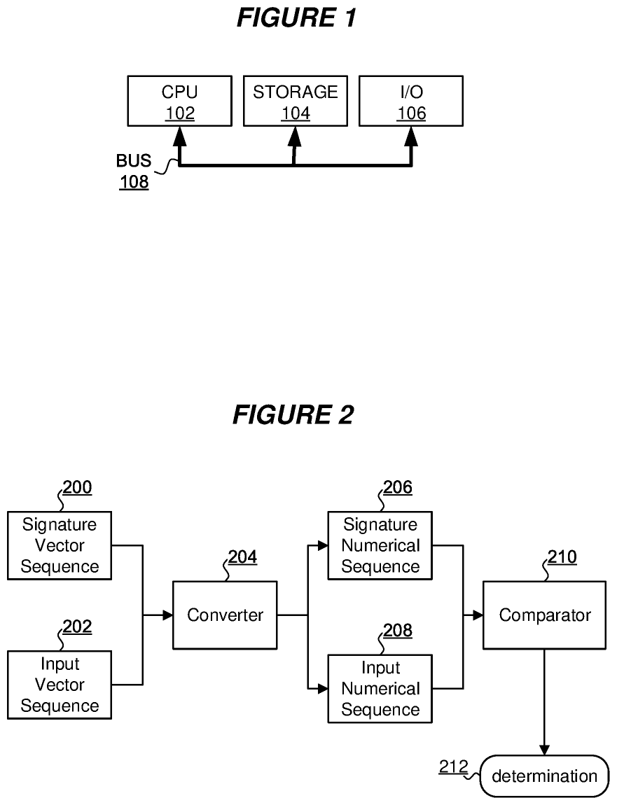

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

A condition of a system such as a computer system, telecommunications system or network can be indicative of an occurrence if interest in the system, such as being susceptible to or subject to attack, a performance issue, an anomalous state of operation or other occurrences as will be apparent to those skilled in the art. Detection of a particular condition of the system can be achieved on the basis of a known sequence of events indicative of the condition. Such events can be represented as a vector sequence of events or transitions between events that serves as a signature of the condition. For example, events can include, inter alia: operations, inputs, outputs or processes of a system; alerts, logs or identifiers generated by a system; locations or transactions; and other events that will be apparent to those skilled in the art. A particular sequence of events in a particular order can thus be indicative of a condition of the system and can be represented by an ordered sequence of vectors. Notably, events and/or relationships between events (such as temporal, geospatial, operational or data relationships) can be represented by vectors through processes such as vector embedding as is well known in the art. Thus, a signature sequence of vectors for a condition of a system can be constituted as an ordered sequence of vectors.

In use, a system in operation can generate a sequence of vectors corresponding to a sequence of events occurring in the system, hereinafter an input vector sequence of events which is also an ordered sequence of vectors. Thus, the signature sequence of vectors is comparable with the input sequence of vectors to identify a similarity therebetween indicative of the existence of the condition of the system represented by the signature sequence in the operational system.

The efficient comparison of ordered sequences of vectors is necessary to ensure fast and effective detection of a condition of a system. Furthermore, the particular characteristics of a signature vector sequence may not match precisely with the characteristics of an input vector sequence so rendering the process of comparison more difficult or inaccurate. For example, whereas a vector in the signature sequence has a first magnitude, in the input sequence a similar vector may have a different magnitude and so the operating condition may go undetected.

Implementations of the present disclosure employ a conversion and comparison process according to which the signature and input vector sequences are converted to ordered numerical sequences for ready comparison. The conversion of ordered sequences of multi-dimensional vectors into ordered numerical sequences permits the application of efficient techniques for sequence comparisons. In particular, processes typically used for applications such as time-series data processing can be applied to such ordered numerical sequences for comparison purposes, such as dynamic time warping (DTW).

DTW is an approach to comparing two or more pieces of time series data. One of the challenges with time series data is that events may not happen with exactly the same timing. For example, in speech recognition, two people can say words “hey digital assistant” in a comprehensible but non-identical manner. DTW copes well with this problem such as by recursively finding the nearest adjacent point for a test sample against a training sample. This has the effect of “warping” the dimension of time such that each event in one sequence is mapped to an event in the other sequence that yields the shortest distance between the two sequences. For example, this can be achieved through the construction of a 2D matrix used to store an accumulated distance of event-to-event comparisons. Each individual distance between two sequence events i and k can be computed as d_{i,k}=|i−k|. This result in N×M distance values for two sequences s1 and s2 of lengths N and M. The accumulated cost for each event-to-event mapping is represented in the matrix by the minimum of (i−1,k)+d_{i,k},(i,k−1)+d_{i,k} and (i−1,k−1)+d_{i,k}. The time complexity for a DTW comparison is O(NM). This provides an optimal matching over naïve matching techniques such as Euclidean distance which make no consideration of the identical but mismatched sections of a signal.

Thus, the conversion to ordered numerical sequences allows for ready comparison and the application of time-series techniques to determine a degree of similarity of a signature vector sequence and an input vector sequence to detect the existence of a condition in a system.

FIG. 2 is a component diagram of an arrangement for detecting the existence of a condition indicated by a signature vector sequence 200 of events in an input vector sequence 202 of events according to an exemplary implementation of the present disclosure. A signature vector sequence 200 is received as an ordered sequence of vectors each corresponding to an event and being suitable for indicating the existence of a condition in a system. An input vector sequence 202 is a sequence of vectors each corresponding to an event in a system in operation. The input vector sequence 202 can be a continuous vector sequence in the sense that events generated during an ongoing operation of the system may result in a continuous sequence of vectors being generated and received.

A converter 204 is provided as a hardware, software, firmware or combination component arranged to covert each vector sequence 200, 202 into an ordered numerical sequence 206, 208 in which each vector in the vector sequence is converted to a number indicative of a magnitude of the vector such that the resulting numerical sequence 206, 208 is a sequence of magnitudes in the order of the signature vector sequence. Thus, the signature vector sequence 200 is converted by the converter 204 to a signature numerical sequence. Similarly, the input vector sequence 202 is converted by the converter 204 to an input numerical sequence 208.

A comparator 210 is provided as a hardware, software, firmware or combination component operable to compare the signature numerical sequence 206 and the input numerical sequence 208 to determine a degree of similarity of the numerical sequences 206, 208. The comparator 210 thus produces a determination 212 of whether the input vector sequence 202 indicates the existence of the condition in the system in operation based on the degree of similarity. In some implementations, the comparator 210 implements time-series techniques for comparing the numerical sequences 206, 208 such as DTW as previously described.

In some implementations, the condition sought is a security condition and responsive to a determination 212 that a degree of similarity of the numerical sequences 206, 208 meets a predetermined threshold degree of similarity, a responsive measure is triggered to mitigate the security condition.

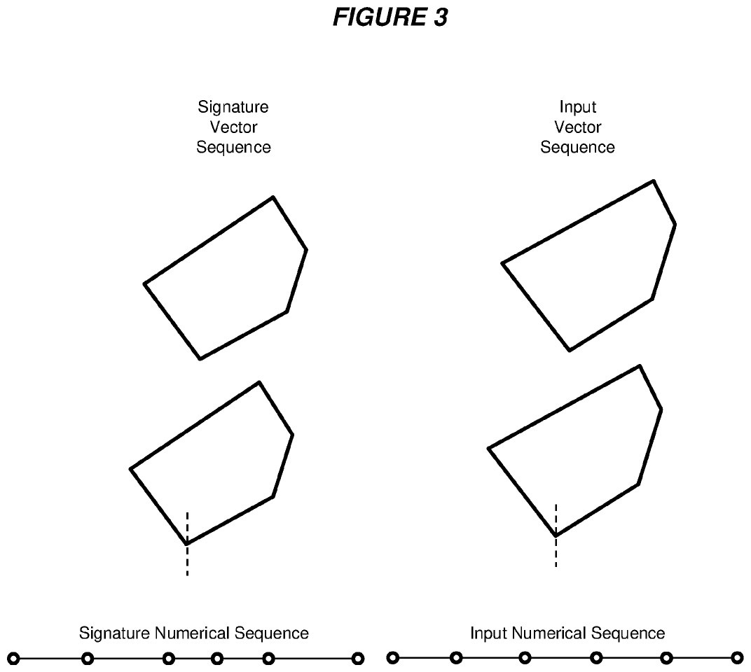

FIG. 3 is an illustration of exemplary signature and input vector sequences suitable for an exemplary implementation of the present disclosure. A signature vector sequence is depicted on the left side of FIG. 3 and again below with a starting point for the vector sequence indicated by a broken line. Further below a signature numerical sequence is depicted. On the right side of FIG. 3 an input vector sequence is depicted with again a starting point for the vector sequence indicated by a broken line beneath and an illustrative input numerical sequence.

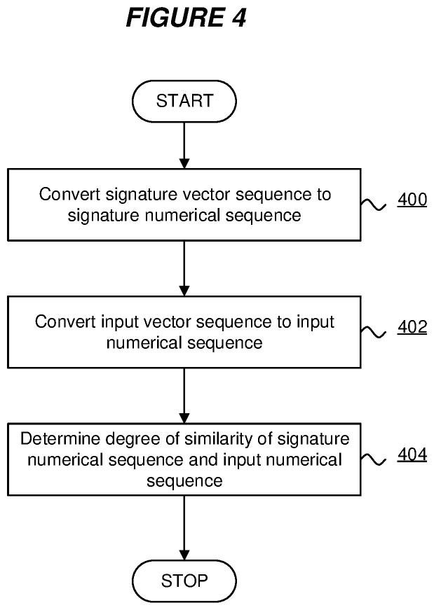

FIG. 4 is a flowchart of a method for detecting the existence of a condition indicated by a signature vector sequence 200 of events in an input vector sequence 202 of events according to an exemplary implementation of the present disclosure. Initially, at 400, the method converts the signature vector sequence 200 to a signature numerical sequence 206. At 402, the method converts the input vector sequence 202 to an input numerical sequence 208. At 404 the comparator 210 determines a degree of similarity of the signature numerical sequence 206 and the input numerical sequence 208.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for detecting an existence of a condition indicated by a signature vector sequence of events in an input vector sequence of events, each of the signature vector sequence and the input vector sequence being constituted by an ordered sequence of vectors, the method comprising:
converting the signature vector sequence into a signature ordered numerical sequence in which each vector in the signature vector sequence is converted to a number indicative of a magnitude of the vector such that the signature numerical sequence is a sequence of magnitudes in an order of the signature vector sequence;
converting the input vector sequence into an input ordered numerical sequence in which each vector in the input vector sequence is converted to a number indicative of a magnitude of the vector such that the input numerical sequence is a sequence of magnitudes in an order of the input vector sequence; and
determining a degree of similarity of the signature numerical sequence and the input numerical sequence to detect the existence of the condition indicated by the input numerical sequence.

2. The method of claim 1, wherein determining the degree of similarity includes applying a dynamic time warping algorithm to measure the degree of similarity between the two sequences.

3. The method of claim 1, wherein the condition is a security condition and responsive to a determination that the degree of similarity meets a predetermined threshold degree of similarity, the method further comprises triggering a responsive measure to mitigate the security condition.

4. A computer system comprising a processor and memory storing computer program code for performing the method of claim 1.

5. A non-transitory computer-readable storage medium storing computer program code to, when loaded into a computer system and executed thereon, cause the computer system to perform the method as claimed in claim 1.
